(19) United States
(12) Patent Application Publication
(10) Pub. No.: US 2026/0185909 A1
(43) Pub. Date: Jul. 2, 2026

(54) DISSOLUTION DETERMINATION APPARATUS AND OPERATING METHOD THEREOF

(71) Applicant: SAMSUNG ELECTRONICS CO., LTD., Suwon-si (KR)

(72) Inventors: Gahee KIM, Suwon-si (KR); Jun-suk KWAK, Suwon-si (KR); Youngchun KWON, Suwon-si (KR); Seung Min BAEK, Suwon-si (KR); Won Je CHOI, Suwon-si (KR); Jeonghun KIM, Suwon-si (KR)

(73) Assignee: SAMSUNG ELECTRONICS CO., LTD., Suwon-si (KR)

(21) Appl. No.: 19/387,123

(22) Filed: Nov. 12, 2025

(30) Foreign Application Priority Data
Dec. 30, 2024 (KR) 10-2024-0101242

(51) Int. Cl. G01N 1/38; G01N 35/00

(52) U.S. Cl. CPC G01N 1/38; G01N 35/00732; G01N 35/0099; G01N 2035/00524; G01N 2035/00831

(57) ABSTRACT

A dissolution determination apparatus and an operating method thereof are provided. The dissolution determination apparatus may include: a dissolution determination apparatus may include: a reader configured to read identification information of a container that accommodates a target sample; a driving module including at least one body, the at least one body of the driving module configured to open the container and move the container to a capturing position; an image obtaining module configured to obtain, at the capturing position, at least one image of the target sample while the container is open; and at least one processor configured to automatically determine whether the target sample is dissolved by analyzing the at least one image of the target sample based on the identification information of the container.

### CROSS-REFERENCE TO RELATED APPLICATION

This application claims priority from Korean Patent Application No. 10-2024-0201242, filed on Dec. 30, 2024, in the Korean Intellectual Property Office, the disclosure of which is incorporated herein by reference in its entirety.

### BACKGROUND

### 1. Field

Methods and apparatuses consistent with embodiments relate to a dissolution determination apparatus and an operating method thereof.

### 2. Description of Related Art

In order to measure solubility, a method of measuring an optical density using a spectrophotometer, or a method of measuring turbidity using a nephelometer or turbidimeter may be used. All of the measurement methods described above are measurement methods that utilize light scattering, and therefore, real-time measurement of solubility is impossible. The methods described above may be methods that measure the degree to which a solute is dissolved in a solution, rather than directly sensing the solubility. The methods described above are methods of measuring a solvent or solute directly or measuring a solvent or solute using absorption density and spectroscopy in order to monitor the dissolution degree, and thus are limited in monitoring the entire region of interest (ROI). In addition, a method of sensing solubility using computer vision may have limitations in expandability because the method measures an image in one fixed direction and an object thereof is to measure solubility.

### SUMMARY

One or more embodiments of the disclosure may address at least the above problems and/or disadvantages and other disadvantages not described above. Also, embodiments of the disclosure are not required to overcome the disadvantages described above, and an embodiment of the disclosure may not overcome any of the problems described above.

According to an aspect of the disclosure, a dissolution determination apparatus may include: a reader configured to read identification information of a container that accommodates a target sample; a driving module including at least one body, the at least one body of the driving module configured to open the container and move the container to a capturing position; an image obtaining module configured to obtain, at the capturing position, at least one image of the target sample while the container is open; and at least one processor configured to automatically determine whether the target sample is dissolved by analyzing the at least one image of the target sample based on the identification information of the container.

The reader may be further configured to sense a position of the container.

The at least one body of the driving module may include at least one from among: a gripper configured to grip the container; a robot configured to transfer the container to the capturing position along a transfer path; an actuator configured to adjust at least one from among a height and a horizontal position of the container; and a capper configured to open the container.

The image obtaining module may include at least one from among: a first camera configured to capture a first image of an upper portion of the target sample while the target sample is in the container and the container is open; a second camera configured to capture a second image of a side of the target sample while the target sample is in the container and the container is open; and a third camera configured to capture a third image of a lower portion of the target sample while the target sample is in the container, and wherein the at least one processor may be configured to automatically determine whether the target sample is dissolved by analyzing at least one from among the first image, the second image, and the third image of the target sample based on the identification information of the container.

The at least one processor may be further configured to: extract a region of interest (ROI) from the at least one image of the target sample; calculate a noise level corresponding to the ROI through frequency-based filtering with respect to the ROI; detect particles of an undissolved solute included in the ROI; and determine whether the target sample is dissolved based on the noise level and the particles of the undissolved solute.

The at least one processor may be further configured to detect the particles of the undissolved solute using at least one from among a bandpass filter, an adaptive thresholding, and a non-linear filter.

The at least one processor may be further configured to: extract features from the ROI; obtain an analysis result by analyzing a dissolution degree of the target sample by applying the features to a neural network trained based on an analysis algorithm; and generate a control signal based on the analysis result.

The analysis algorithm may be configured to analyze at least one from among whether the target sample is completely dissolved, opacity of the target sample, the particles of the undissolved solute in the target sample, and a residue around the container.

The at least one processor may be further configured to: determine dissolution conditions corresponding to the target sample according to the identification information of the container; and generate, based on determining that the target sample is not completely dissolved, a control signal for accelerating the dissolution of the target sample according to the dissolution conditions.

The dissolution conditions may include at least one from among a type of a solvent for the dissolution of the target sample; an amount of the solvent; a type of a catalyst for the dissolution of the target sample; an amount, a temperature, a humidity, or a pressure of the catalyst; and a number of agitations of the container.

According to an aspect of the disclosure, a method performed by a dissolution determination apparatus may include: reading identification information of a container that accommodates a target sample; opening the container; moving the container to a capturing position; obtaining, at the capturing position, at least one image of the target sample while the container includes the target sample and the container is open; and automatically determining whether the target sample is dissolved by analyzing the at least one image of the target sample based on the identification information of the container.

The opening the container may include: adjusting at least one from among a height and a position of the container; and opening the container after the at least one from among the height and the position of the container is adjusted.

The obtaining the at least one image of the target sample may include: capturing a first image of an upper portion of the target sample while the container includes the target sample and is open; capturing a second image of a side of the target sample while the container includes the target sample and is open; and capturing a third image of a lower portion of the target sample while the container includes the target sample.

The automatically determining whether the target sample is dissolved may include: extracting a region of interest (ROI) from the at least one image of the target sample; and determining whether the target sample is dissolved based on frequency-based filtering with respect to the ROI.

The determining whether the target sample is dissolved based on the frequency-based filtering may include: calculating a noise level corresponding to the ROI using image entropy; detecting particles of an undissolved solute included in the ROI through the frequency-based filtering with respect to the ROI; and determining whether the target sample is dissolved based on the noise level and the particles of the undissolved solute.

The detecting the particles of the undissolved solute may include: detecting the particles of the undissolved solute using at least one from among a bandpass filter, an adaptive thresholding, and a non-linear filter.

The automatically determining whether the target sample is dissolved may include: extracting features from the ROI; obtaining an analysis result by analyzing a dissolution degree of the target sample by applying the features to a neural network trained based on an analysis algorithm; and generating a control signal based on the analysis result.

The analysis algorithm may analyze at least one from among whether the target sample is completely dissolved, opacity of the target sample, particles of an undissolved solute in the target sample, and a residue around the container.

The automatically determining whether the target sample is dissolved may include: determining dissolution conditions corresponding to the target sample according to the identification information of the container; and generating, based on determining that the target sample is not completely dissolved, a control signal for accelerating the dissolution of the target sample according to the dissolution conditions.

According to an aspect of the disclosure, the dissolution conditions may include at least one from among a type of a solvent for the dissolution of the target sample; an amount of the solvent; a type of a catalyst for the dissolution of the target sample; an amount, a temperature, a humidity, or a pressure of the catalyst; and a number of agitations of the container.

Additional aspects of embodiments of the disclosure will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a block diagram of a dissolution determination apparatus according to an embodiment;

FIG. 2A is a front view of a dissolution determination apparatus according to an embodiment;

FIG. 2B is a bird's-eye view of a dissolution determination apparatus according to an embodiment;

FIG. 2C is a side view of a dissolution determination apparatus according to an embodiment;

FIG. 3 is a flowchart illustrating a method of operating a dissolution determination apparatus according to an embodiment;

FIG. 4 is a flowchart illustrating a method of operating a dissolution determination apparatus according to an embodiment;

FIG. 5 is a diagram illustrating a method of extracting a region of interest (ROI) from an image of a target sample according to an embodiment;

FIG. 6 is a diagram illustrating a method of calculating a noise level corresponding to a ROI according to an embodiment;

FIG. 7 is a diagram illustrating a method of determining whether a target sample is dissolved according to an embodiment; and

FIG. 8 is a flowchart illustrating a method of operating a dissolution determination apparatus according to an embodiment.

### DETAILED DESCRIPTION

The following detailed structural or functional description is provided to explain non-limiting example embodiments of the disclosure, and embodiments of the disclosure may include various alterations and modifications. Accordingly, embodiments of the disclosure are not limited to the example embodiments, and should be understood to include all changes, equivalents, and replacements within the spirit and scope of the disclosure.

Although terms, such as “first,” “second,” and the like are used to describe various components, the components are not limited to the terms. These terms may be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art, and are not to be construed to have an ideal or excessively formal meaning unless otherwise defined herein.

Hereinafter, non-limiting example embodiments of the disclosure will be described in detail with reference to the accompanying drawings. When describing the example embodiments with reference to the accompanying drawings, like reference numerals refer to like elements and a repeated description related thereto may be omitted.

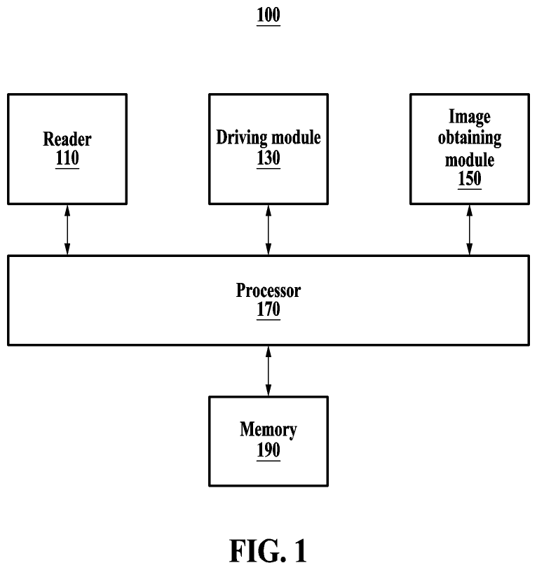

FIG. 1 is a block diagram of a dissolution determination apparatus according to an embodiment. Referring to FIG. 1, a dissolution determination apparatus (hereinafter, referred to as a “determination apparatus 100”) according to an embodiment may include a reader 110, a driving module 130, an image obtaining module 150, and a processor 170. The determination apparatus 100 may further include a memory 190.

The determination apparatus 100 may be a measurement apparatus that automatically determines whether a compound is dissolved based on optics and computer vision. The determination apparatus 100 may automate the entire process of measuring solubility and determining whether a compound is dissolved to perform the entire process without human intervention. The determination apparatus 100 may operate in a closed-loop manner through feedback with other systems before and after operation.

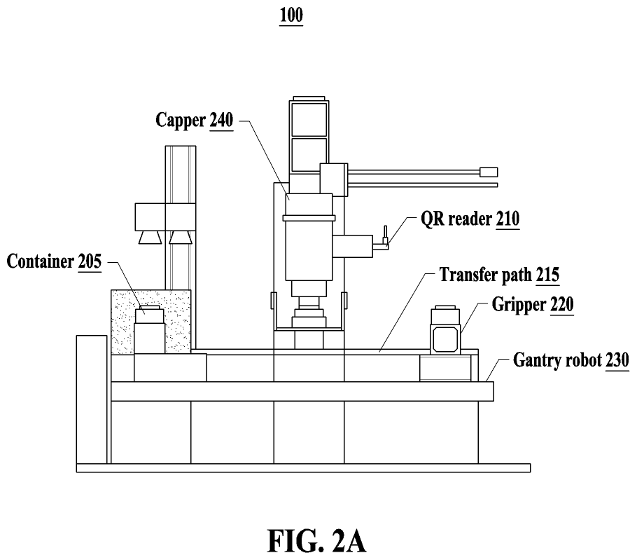

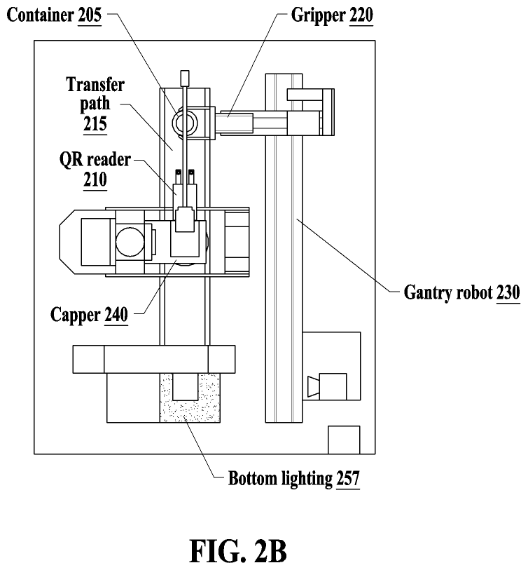

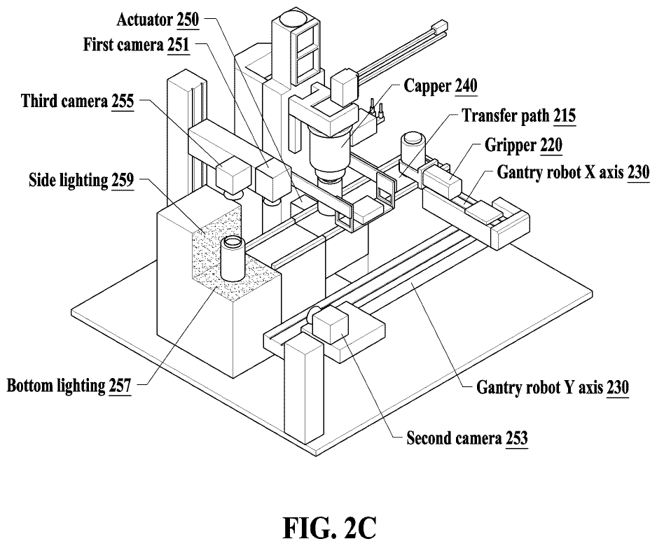

The reader 110 may read identification information of a container (e.g., a container 205 of FIG. 2A) that accommodates a target sample. The “target sample” may be a sample that is a measurement target for determining solubility or whether the sample is dissolved. A target sample may include at least one from among a solid sample, a liquid sample, and a mixed sample of a solid sample and a liquid sample. A liquid sample may be in various forms of a liquid, paste, sludge, and viscous oil. A solid sample may be in various forms of, for example, powder, granule, pellet, film, and/or fiber. When the target sample is a solid sample such as a film, the determination apparatus 100 may analyze, for example, not only solubility of the target sample but also homogeneity of the target sample or whether turbidity of the target sample increases due to a reaction.

The container may be a vial for storing liquid pharmaceutical, reagent, powder, and/or pill, or a flask that accommodates a sample, but is not limited thereto. When the target sample is a liquid sample, the container may have various shapes that may store the liquid sample without spilling. When the target sample is a liquid sample, the container may include, for example, a transparent flask or a cuvette. When the target sample is a solid sample, the container may be a flat container in which the solid sample may be placed. When the target sample is a solid sample, the container may include, for example, a plate or a slide. Hereinafter, for convenience of description, a description will be provided based on a case in which the target sample is a liquid sample. However, the description does not exclude a case in which the target sample is a solid sample.

Hereinafter, the “container that accommodates the target sample” may be understood as a container that accommodates a solution in which a target sample (solute) is dissolved in a solvent, even though there is no separate description. Below, the target sample and the solute may be interchangeably used with each other.

The reader 110 may read at least one from among a position of the container and the identification information of the container. The reader 110 may be, for example, a quick-response (QR) reader that reads a QR code attached to the container, or a label reader that reads a label attached to the container, but is not limited thereto.

The driving module 130 may open the container by moving the container that accommodates the target sample to or towards a capturing position. For example, the driving module 130 may detach a cap from the container. According to some embodiments, the cap may be configured to attach to an upper end of the container such that the container becomes closed, and detach from the upper end of the container such that the container is opened. The driving module 130 may fix and/or move the container that accommodates the target sample according to a control signal of the processor 170. Here, the “movement” may be understood as, for example, a rotation, translation, and/or displacement. According to some embodiments, the driving module 130 may open the container at the capturing position, or a position before the container reaches the capturing position. According to some embodiments, the capturing position may be a position in which at least one image of the container is captured by the image obtaining module 150.

The driving module 130 may perform rotational driving for the container and/or equipment for fixing the container according to the control signal of the processor 170. The driving module 130 may rotate the container clockwise or counterclockwise according to the control signal of the processor 170. The driving module 130 may change a posture of the container and/or the equipment for fixing the container according to the control signal of the processor 170.

The driving module 130 may include at least one from among a gripper (e.g., a gripper 220 of FIG. 2A), a robot (e.g., a gantry robot 230 of FIG. 2A), an actuator (e.g., an actuator 250 of FIG. 2C), and a capper (e.g., a capper 240 of FIG. 2A).

The gripper may hold the container so that the container does not shake.

The robot may transfer the container to the capturing position along a transfer path. The robot may be, for example, a gantry robot that moves along X and Y axes. The gantry robot may be a Cartesian coordinate robot that performs a task by moving along orthogonal axes, denoted as the X-axis, Y-axis, and/or Z-axis, from a fixed position. Here, the X-axis may be a first horizontal axis, the Y-axis may be a second horizontal axis that is perpendicular to the first horizontal axis, and the Z-axis may be a vertical axis that is perpendicular to the first horizontal axis and the second horizontal axis. A length of each axis may correspond to an operating range of the gantry robot. The gantry robot may transfer the container to the capturing position along the transfer path using a device (e.g., a gripper) that may grip a part.

The actuator may adjust at least one from among the height and the horizontal position of the container that accommodates the target sample. The actuator may adjust the height and/or the horizontal position of the container for the capper.

The capper may open or close the container, of which at least one from among the height and the horizontal position is adjusted, by attaching or detaching a cap from the container.

The image obtaining module 150 may obtain an image of the target sample while the container that accommodates the target sample is open (e.g., the cap is removed from the container). The image obtaining module 150 may capture the image of the target sample by changing a capturing angle according to the control signal of the processor 170.

The image obtaining module 150 may include at least one from among cameras (e.g., a first camera (e.g., a first camera 251 of FIG. 2C), a second camera (e.g., a second camera 253 of FIG. 2C), and/or a third camera (e.g., a third camera 255 of FIG. 2C)) that capture the image of the target sample in various directions, light sources (e.g., a bottom light source 257 and/or a side light source 259 of FIG. 2C) for capturing of the cameras, and a reflector.

The processor 170 may obtain at least two images obtained by capturing the target sample by changing the capturing position or changing a display image by rotating the cameras of the image obtaining module 150, and then, compare the at least two images to determine whether the target sample is dissolved. In an embodiment, by capturing the target sample accommodated in the container in various directions, errors that may occur when measuring an image in one direction may be avoided.

Alternatively, the processor 170 may obtain the image of the inside of the container, that is, the image of the target sample by the image obtaining module 150, while or after the container is rotated up, down, left, and/or right by the driving module 130.

The processor 170 may determine whether the target sample is dissolved with higher accuracy by performing image processing on the image obtained by the image obtaining module 150 by utilizing an image processing algorithm. The image processing algorithm may detect the size and number of particles in an undissolved solute from the captured image of target sample. Also, the image processing algorithm may measure the solubility of the solution, turbidity, and the amount of undissolved solute remaining in the solution in real time.

For example, when the solute is determined by the processor 170, via the image processing algorithm, to be completely dissolved in the solution accommodated in the container, that is, a completely dissolved state, the processor 170 may output “Pass.” When it is determined by determined by the processor 170, via the image processing algorithm, that the undissolved solute is present in the solution accommodated in the container or the dissolution degree of the target sample is a supersaturated state (crystallized state) or a turbid state, in other words, when the solution accommodated in the container is in an undissolved state, the processor 170 may output “Fail.”

Also, the processor 170 may divide the dissolution degree of the target sample into several states and output the states of the dissolution as the analysis results. For example, when the dissolution degree of the target sample is the turbid state, the processor 170 may output “Fail #1” as the analysis result. In addition, when the dissolution degree of the target sample is the supersaturated state (crystallized state), the processor 170 may output “Fail #2” as the analysis result. As the processor 170 outputs the analysis results by dividing the analysis results into Pass, Fail #1, and Fail #2 according to the degree of dissolution of the target sample, the user may intuitively determine the dissolution degree of the target sample.

The processor 170 may automatically determine whether the target sample is dissolved by analyzing the image of the target sample based on the identification information of the container that accommodates the target sample. The identification information of the container accommodating the target sample may include, in addition to the information that may identify the target sample (e.g., the ID or QR code), information on the name of a solvent, the name of a solute, the name of a catalyst contained in the target sample, and the volumes thereof. The processor 170 may automatically determine whether the target sample is dissolved by identifying the solute remaining undissolved in the image of the target sample or the state of the solution containing the completely dissolved solute based on the identification information.

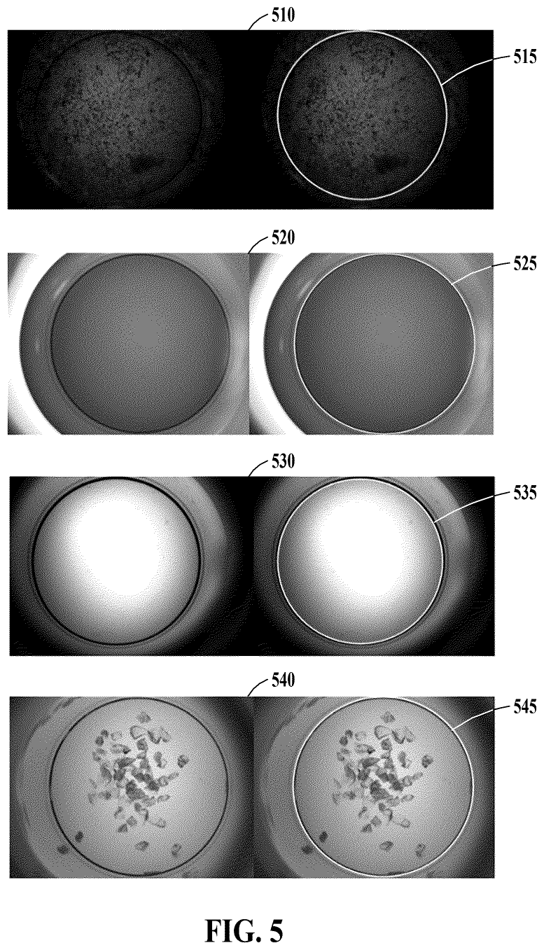

More specifically, the processor 170 may extract a region of interest (ROI) from the image of the target sample. A method of detecting the ROI by the determination apparatus will be described in more detail with reference to FIG. 5 below.

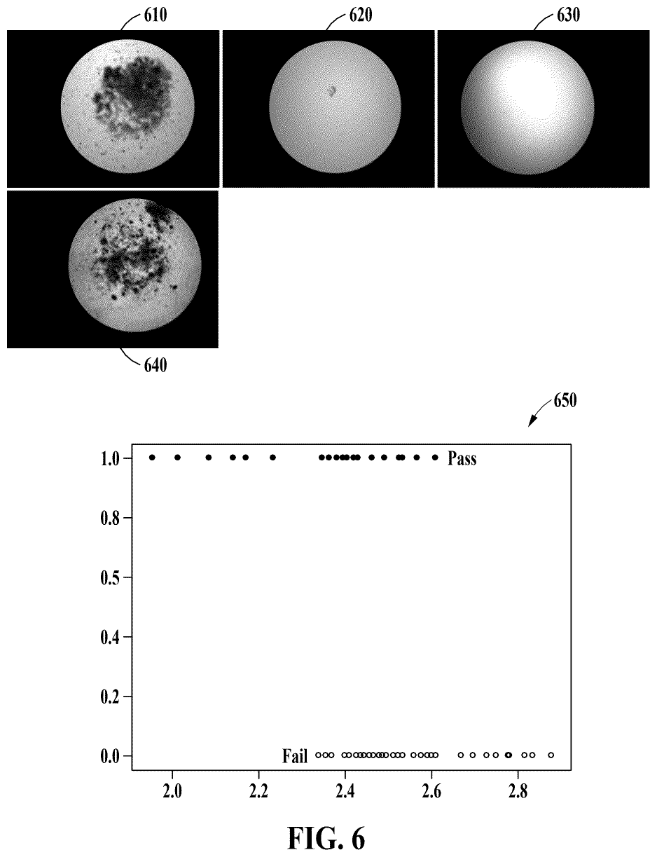

The processor 170 may calculate a noise level corresponding to the ROI through frequency-based filtering with respect to the ROI. A method of calculating the noise level corresponding to the ROI by the determination apparatus will be described in more detail with reference to FIG. 6 below.

The processor 170 may detect particles of the undissolved solute contained in the ROI. The processor 170 may detect the particles of the undissolved solute using at least one from among a bandpass filter, an adaptive thresholding, and a non-linear filter. The processor 170 may determine whether the target sample is dissolved based on the noise level and the particles of the undissolved solute.

Also, the processor 170 may extract features from the ROI. The processor 170 may analyze the dissolution degree of the target sample as one of, for example, a completely dissolved state, a supersaturated state, and a turbid state based on the extracted features. The processor 170 may analyze the dissolution degree of the target sample by, for example, inputting the features extracted from the ROI to the analysis algorithm, or may analyze the dissolution degree of the target sample by applying the extracted features to a neural network trained based on the analysis algorithm. The analysis algorithm may analyze at least one from among whether the target sample is completely dissolved, the opacity of the target sample, the particles of the undissolved solute in the target sample, and a residue (e.g., bubbles, water droplets, dust, or the like) around the container.

The processor 170 may generate a control signal based on the analysis results. The control signal may include, for example, a control signal for causing the driving module 130 to fix or move the container based on the analysis results. In addition, the processor 170 may generate different control signals depending on, for example, whether the analysis result is successful or unsuccessful. For example, when the analysis result is successful (Pass), the processor 170 may generate a control signal for proceeding with a process (e.g., filtration) after determining whether the target sample is dissolved. Alternatively, when the analysis result is unsuccessful (Fail), the processor 170 may generate a control signal for adding a solvent to the container, adjusting the temperature of the container, adjusting an agitation speed by the driving module 130, or increasing the reaction time of the target sample.

The processor 170 may determine dissolution conditions corresponding to the target sample according to the identification information of the container. The processor 170 may generate a control signal for accelerating the dissolution of the target sample according to the dissolution conditions based on whether the target sample is completely dissolved. The dissolution conditions may include at least one from among a type of a solvent for the dissolution of the target sample; an amount of the solvent; a type of a catalyst for the dissolution of the target sample; an amount, a temperature, a humidity, and/or a pressure of the catalyst; and the number of agitations of the container that accommodates the target sample, but are not limited thereto.

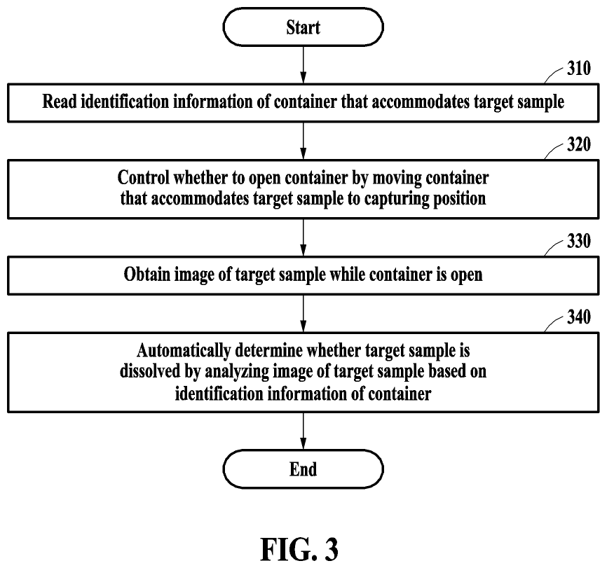

The processor 170 may include a processor module of a user terminal such as, for example, a personal computer (PC), a notebook, or a tablet. Alternatively, the processor 170 may drive a neural network-based analysis model by executing at least one program stored in the memory 190. According to some embodiments, the processor 170 may include one or more processors. According to some embodiments, the memory 190 may store at least one program and the program, when executed by the processor 170, may be configured to cause the processor 170 to perform its functions. For example, the program may be configured to cause the processor 170 to perform the operations of the methods described below with reference to FIGS. 3-8.

The processor 170 may analyze the dissolution degree of the target sample, the presence of undissolved solute particles in the target sample, and/or the presence of the residue around the container from the image obtained by the image obtaining module 150 using a pre-trained neural network-based analysis model stored in the memory 190, and output the analysis results. The analysis model may be trained based on various analysis algorithms. The analysis model according to an embodiment may be implemented by various types of devices, such as, for example, a PC, a server device, a mobile device, and an embedded device. The analysis model may be implemented by an automatic material retrieval apparatus that performs image recognition, image classification, and the like using a neural network, but is not limited thereto. Furthermore, the analysis apparatus may be a dedicated hardware (HW) accelerator installed in the above-described devices, or may be an HW accelerator such as a neural processing unit (NPU), a tensor processing unit (TPU), a neural engine and the like, which are dedicated modules for operating a neural network, but is not limited thereto.

The memory 190 may store at least one program. In addition, the memory 190 may store a variety of information generated during the processing of the processor 170. The memory 190 may store a neural network trained based on the analysis algorithm. In addition, the memory 190 may store a variety of data and programs. The memory 190 may include, for example, a volatile memory or a non-volatile memory. The memory 190 may include a high-capacity storage medium such as a hard disk to store a variety of data.

In addition, the processor 170 may perform at least one method that will be described with reference to FIGS. 2 to 8 below, in addition to FIG. 1, or a scheme corresponding to the at least one method. The processor 170 may be a HW-implemented dissolution determination apparatus, solubility measurement apparatus, or analysis apparatus having a physically structured circuit to execute desired operations. The desired operations may be implemented by, for example, code or instructions included in a program. The determination apparatus 100, which may be implemented by hardware, may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The determination apparatus 100 may be utilized for monitoring the dissolution state of a compound, determining the dissolution degree of a biomaterial, and/or retrieving conditions for separation and analysis of a material, and/or as a water level sensor. In addition, the determination apparatus 100 may be utilized in the development of catalyst synthesis for cosmetics and fuel cells, which may require high capacity and high efficiency.

FIG. 2A is a front view of a dissolution determination apparatus according to an embodiment. FIG. 2B is a bird's-eye view of a dissolution determination apparatus according to an embodiment. FIG. 2C is a side view of a dissolution determination apparatus according to an embodiment.

Referring to FIGS. 2A, 2B, and 2C, the operation of the determination apparatus 100 according to an embodiment may largely include four stages: an input/output (I/O) stage, a capping stage, an image capturing stage, and an image processing stage.

The I/O stage (“first stage”) may be a process of identifying a container to determine whether the target sample is dissolved. In the I/O stage, the determination apparatus 100 may verify the position of a container 205 (e.g., a formulation vial) containing a sample to be analyzed for the dissolution by a reader (e.g., a QR reader 210) before and after measuring whether the target sample is dissolved, and the identification information (ID) of the container.

The capping stage (“second stage”) may be a process of moving a container accommodating the target sample to the capturing position and opening the container (e.g., removing a cap from the container). In the capping stage, the determination apparatus 100 may grip the container 205 by the gripper 220 and open/close (cap/decap) the container by the capper 240, which may be a device for opening and closing the container 205 by removing the cap from the container 205 and attaching the cap to the container 205, respectively. The gripper 220 may include a polytetrafluoroethylene (PTFE) material or a tip coated with PTFE so that the position of the container 205 is not changed by friction or adhesive force when the container 205 is placed.

In addition, the determination apparatus 100 may adjust the height of the container 205 by the actuator 250 in the capping stage and then transfer the container 205 along a transfer path 215 by the gantry robot 230. The actuator 250 may include two actuators configured to move the container 205 along the X-axis and the Y-axis. The transfer path 215 may be a path, along which the container 205 moves, and may be defined by a body that includes, for example, the PTFE material. Where each stage (e.g., the input/output (I/O) stage, the capping stage, the image capturing stage, and the image processing stage) is performed along the transfer path 215 may be based on a height or volume of the container 205. The determination apparatus 100 may adjust the transfer speed of the container 205 along the transfer path 215 depending on progress of a method including the stages.

The image capturing stage (“third stage”) may be a process of capturing the image of the target sample. In the image capturing stage, the determination apparatus 100 may obtain the image of the target sample by at least two cameras from among the first camera 251, the second camera 253, and the third camera 255, and by at least one light source (e.g., the bottom light source 257 and the side light source 259) and other auxiliary devices for capturing (e.g., a reflector).

The first camera 251 may be a camera that captures a first image corresponding to the upper portion of the target sample while the container is open. The first camera 251 may be referred to as an “upper portion capturing camera.” The second camera 253 may be a camera that captures a second image corresponding to the side of the target sample while the container is open. The second camera 253 may be referred to as a “side capturing camera.” The third camera 255 may be a camera that captures a third image corresponding to the lower portion of the target sample. The third camera 255 may be referred to as a “lower portion capturing camera.” The third camera 255 may capture a third image corresponding to the lower portion of the target sample regardless of whether the container is open.

At this time, the determination apparatus 100 may capture the image of the target sample using a pattern or pattern background image to obtain a structured light effect, thereby distinguishing the image of the target sample more clearly. The structured light may be a structured light source that projects a known pattern or pattern background image onto a captured image of a target sample. The pattern background image may include one or more from among a white image, a check pattern image, and/or a radial pattern image, but is not limited thereto. The pattern background image may have various background patterns, various colors, and various brightness to facilitate the detection of a target to be detected (e.g., the opacity of a solution, the presence or absence of undissolved sample particles in a solution, and/or a residue around a container, or the like). In addition, the pattern background image may have patterns designed in various forms according to, for example, solubility of a solution in which a current target sample is dissolved, and properties of a solvent that dissolves the target sample and a solute (the target sample).

The image processing stage (“fourth stage”) may be a process of automatically determining whether the target sample is dissolved from the captured image(s). In the image processing stage, the determination apparatus 100 may perform the image processing on the image obtained in the image capturing stage using the image processing algorithm described above, thereby automatically determining whether the target sample is dissolved as “Pass” or “Fail” with higher accuracy. Here, the image processing algorithm may detect the size and number of particles in the undissolved solute from the captured image of the target sample. Also, the image processing algorithm may measure the solubility of the solution, turbidity, and the amount of undissolved solute remaining in the solution in real time.

FIG. 3 is a flowchart illustrating a method of operating a dissolution determination apparatus according to an embodiment. Operations to be described hereinafter with reference to FIG. 3 may be performed sequentially, or non-sequentially. For example, the order of the operations may be changed and at least two of the operations may be performed in parallel.

Referring to FIG. 3, the determination apparatus according to an embodiment may automatically determine whether a target sample is dissolved through operations 310 to 340.

In the operation 310, the determination apparatus may read identification information of a container that accommodates a target sample.

In the operation 320, the determination apparatus may control whether to open the container (e.g., remove a cap from the container) by moving the container that accommodates the target sample to or towards a capturing position. The determination apparatus may transfer the container that accommodates the target sample to the capturing position along a transfer path. The determination apparatus may adjust at least one from among the height and the horizontal position of the container. The determination apparatus may control whether to open the container after the at least one from among the height and position of the container is adjusted. For example, the determination apparatus may control the capper to open the container.

In the operation 330, the determination apparatus may obtain an image of the target sample while the container is open. The determination apparatus may capture a first image corresponding to the upper portion of the target sample while the container is open. The determination apparatus may capture a second image corresponding to the side of the target sample while the container is open. The determination apparatus may capture a third image corresponding to the lower portion of the target sample.

In the operation 340, the determination apparatus may automatically determine whether the target sample is dissolved by analyzing the image of the target sample based on the identification information of the container read in operation 310. The determination apparatus may extract a ROI from the image of the target sample. A method of detecting the ROI by the determination apparatus will be described in more detail with reference to FIG. 5 below.

The determination apparatus may determine whether the target sample is dissolved based on frequency-based filtering of the ROI. The decision apparatus may calculate a noise level corresponding to the ROI by, for example, using image entropy.

The determination apparatus may calculate the noise level of the ROI using image entropy. Here, the image entropy may be an indicator for measuring the complexity and uncertainty of an image. A higher entropy may imply that the image contains a large amount of information and less noise. The determination apparatus may evaluate the amount of information in the image through entropy based on the probability distribution of each pixel value in the image.

The method of calculating the noise level using the image entropy is as follows. The determination apparatus may calculate entropy based on the probability distribution of each pixel value in the image by, for example, Equation 1 below.

$$H ( X ) = - {\sum }_{i} P ( {x}_{i} ) log P ( {x}_{i} ) \qquad [ Equation 1 ]$$

Here, P(xᵢ) may correspond to the probability of a pixel value (xᵢ).

The determination apparatus may compare the entropy of an ideal image without noise (e.g., an image in which the target sample is completely dissolved) and the entropy of an actual image (e.g., an image of the target sample accommodated in the container) to calculate an entropy difference. The determination apparatus may estimate the noise level using the entropy difference. A method of calculating the noise level using image entropy by the determination apparatus will be described in more detail with reference to FIG. 6 below.

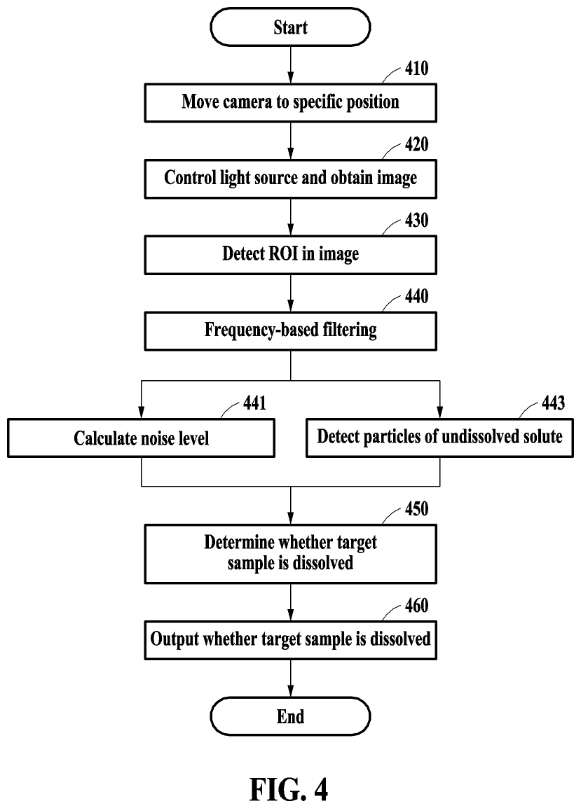

The determination apparatus may detect particles of the undissolved solute included in the ROI through the frequency-based filtering with respect to the ROI. A method of detecting the particles of the undissolved solute by the determination apparatus will be described in more detail with reference to FIG. 4 below.

The determination apparatus may determine whether the target sample is dissolved based on the noise level and the particles of the undissolved solute.

According to an embodiment, the determination apparatus may analyze the dissolution degree of the target sample by extracting features from the ROI and applying the extracted features to a neural network trained based on an analysis algorithm. The determination apparatus may generate a control signal based on the analysis results. The analysis algorithm may analyze at least one from among whether the target sample is completely dissolved, the opacity of the target sample, the particles of the undissolved solute in the target sample, and a residue around the container.

Alternatively, the determination apparatus may determine dissolution conditions corresponding to the target sample according to the identification information of the container. The determination apparatus may generate a control signal for accelerating the dissolution of the target sample according to the dissolution conditions based on whether the target sample is completely dissolved. When it is determined that the target sample is not completely dissolved, the determination apparatus may generate the control signal for accelerating the dissolution of the target sample according to the dissolution conditions. The dissolution conditions may include at least one from among a type of a solvent for the dissolution of the target sample; an amount of the solvent; a type of a catalyst for the dissolution of the target sample; an amount, a temperature, a humidity, and/or a pressure of the catalyst; and the number of agitations of the container, but are not limited thereto.

FIG. 4 is a flowchart illustrating a method of operating a dissolution determination apparatus according to an embodiment. Referring to FIG. 4, the determination apparatus according to an embodiment may automatically determine whether the target sample is dissolved through operations 410 to 450.

In the operation 410, the determination apparatus may move the camera(s) to a specific position. Here, the “specific position” may be, for example, a position for precisely capturing at least one image of the container that accommodates a solution in which the target sample is dissolved. The determination apparatus may move and fix the positions of the cameras (e.g., the first camera, the second camera, and/or the third camera) included in the image obtaining module to the specific positions by the driving module described above.

In the operation 420, the determination apparatus may control a light source to obtain at least one image (e.g., the image of the target sample).

In the operation 430, the determination apparatus may detect a ROI within the at least one image obtained in the operation 420. The determination apparatus may detect the container through an outline of the container within the at least one image and detect the ROI inside the container. Alternatively, the determination apparatus may detect the ROI from the at least one image using geometrical characteristics, color information, or the like of the solvent and/or solute (the target sample). A method of detecting the ROI by the determination apparatus will be described in more detail with reference to FIG. 5 below.

In the operation 440, the determination apparatus may perform the frequency-based filtering with respect to the ROI detected in operation 430. The frequency-based filtering may be used to remove noise from a specific portion of an image or to emphasize a specific frequency component. The determination apparatus may transform the ROI into a frequency domain such as, for example, using the Discrete Fourier Transform (DFT). The determination apparatus may transform the frequency domain to a spatial domain again by applying various filters, such as, a low pass filter (LPF) or a high pass filter (HPF), in the frequency domain. The determination apparatus may remove the noise from the specific portion of the image or emphasize the specific frequency component by applying the filtered result to the ROI.

In the frequency-based filtering process of the operation 440, the determination apparatus may calculate the noise level of the ROI through the operation 441. A method of calculating the noise level of the ROI by the determination apparatus will be described in more detail with reference to FIG. 6 below.

In addition, in the frequency-based filtering process of the operation 440, the determination apparatus may detect particles of the undissolved solute through the operation 443. The determination apparatus may detect the particles of the undissolved solute using at least one from among a bandpass filter, an adaptive thresholding, and a non-linear filter. Alternatively, the determination apparatus may detect the particles of the undissolved solute in the solution in which the target sample is dissolved by applying a fine particle tracking algorithm.

The determination apparatus may detect the particles of the undissolved solute using the adaptive thresholding scheme for obtaining a clearer image by dividing an image (ROI) into a plurality of regions, calculating a mean or gaussian of a region based on surrounding pixel values, and designating a threshold for each region.

In the operation 450, the determination apparatus may determine whether the target sample is dissolved based on the noise level calculated in the operation 441 and the particles of the undissolved solute detected in operation 443.

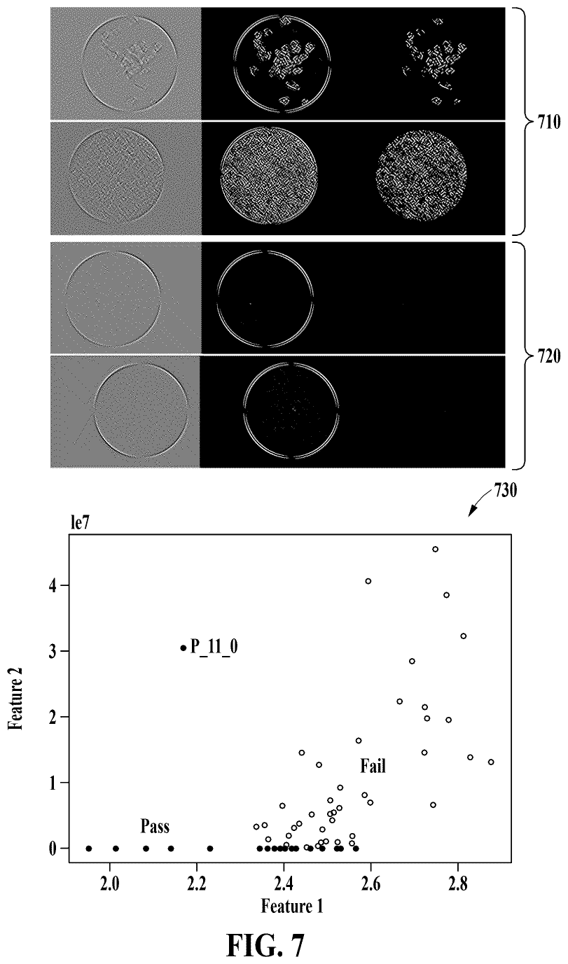

In the operation 460, the determination apparatus may output an indication of whether the target sample is dissolved based on the determination in the operation 450. For example, when it is determined in operation 450 that the target sample is in an undissolved state as shown in a diagram 710 of FIG. 7, that is, a supersaturated state in which solute particles are present in the solution, the determination apparatus may output “Fail.” Alternatively, when it is determined in the operation 450 that the target sample is in a completely dissolved state as shown in a diagram 720 of FIG. 7, the determination apparatus may output “Pass.”

FIG. 5 is a diagram illustrating a method of extracting a ROI from an image of a target sample according to an embodiment. Referring to FIG. 5, various images 510, 520, 530, and 540 of the target sample according to an embodiment are illustrated.

The determination apparatus may detect the ROI inside the container by detecting outlines 515, 525, 535, and 545 of the container within the images 510, 520, 530, and 540 of the target sample. In other words, the determination apparatus may detect a region inside the outlines 515, 525, 535, and 545 of the container as the ROI.

More specifically, since an out-focused image may be present among the images 510, 520, 530, and 540 of the target sample, the determination apparatus may blur the images 510, 520, 530, and 540 of the target sample to make the images be in the same frequency band.

The determination apparatus may apply the HPF to the images of the target sample made to be in the same frequency band, and generate binary images corresponding to the images 510, 520, 530, and 540 of the target sample through appropriate thresholding. The determination apparatus may detect the ROI by detecting the outlines 515, 525, 535, and 545 of the container by applying the Hough circle detection method to the binary images.

The Hough circle detection method may correspond to an algorithm for finding a circle in an image. The Hough circle detection method may detect the center and radius of a circle using the Hough transform. The determination apparatus may detect edges in a binary image by, for example, using a Canny edge detector. The determination apparatus may apply the Hough transform to detect the circle in the detected edge image. The Hough transform method may extract a circle by selecting a two-dimensional histogram for center points (a, b) of a circle using the gradient method from edges detected in the image, and increasing all points of the accumulation plane along a line segment of a gradient from a minimum distance to a maximum distance for all points. At this time, the accumulation plane may be a three-dimensional accumulation plane including a center point x of the circle, a center point y of the circle, and a radius r of the circle. The determination apparatus may display the detected circle (e.g., the outlines 515, 525, 535, and 545 of the container) on an original image, and detect the region inside the outlines 515, 525, 535, and 545 of the container as the ROI.

Alternatively, the determination apparatus may detect the ROI from the image using geometrical characteristics, color information, or the like of the solvent and/or solute (the target sample).

FIG. 6 is a diagram illustrating a method of calculating a noise level corresponding to a ROI according to an embodiment.

Since the focus of the camera that has captured the images (the images of the target sample) may be different, the determination apparatus may perform blurring (e.g., Gaussian blurring) to make the ROI of each image be in the same frequency band. When the blurring is not performed, the in-focused and out-focused images may not be processed identically.

The determination apparatus may detect noise in the image by applying an edge filter to the blurred ROI. The noise in the image may correspond to particles of a floating matter included within the ROI and/or an undissolved solute included within the ROI. According to an embodiment, the determination apparatus may perform normalization and/or discretization after applying the edge filter to the blurred ROI.

The determination apparatus may perform primary masking for masking the images of the target sample with respect to the outline 515, 525, 535, and 545 of the container detected through FIG. 5. The determination apparatus may accurately detect and/or determine the particles of the solute inside the container by, for example, masking the outside of the outlines 515, 525, 535, and 545 of the container to eliminate the effect on the image due to the reflection on a wall of the container.

In a comparative embodiment, the determination apparatus may detect the particles of the solute inside based on the edges during the operation for binarization, and in this process, the outlines of the container may have excessive influence, which may cause false detection. In an embodiment of the disclosure, the false detection may be resolved by using a mask, while the masking operation may affect the overall distribution of pixels, such as binarization, to improve the detection performance. For example, in a portion where exposure is severe due to uneven exposure, a problem such as local saturation, where edges also appear large, may occur, and thus, it may be difficult to extract the desired information using a simple threshold in a comparative embodiment.

In an embodiment of the disclosure, the noise in the image may be detected using the adaptive thresholding that takes background removing into account. The adaptive thresholding may be a technique that performs binarization by dynamically determining a threshold for each portion of the image. This may effectively remove a background or detect an object even in an image with uneven lighting.

The determination apparatus may determine whether the target sample is dissolved through the noise detected in the image.

Here, diagrams 610, 620, 630, and 640 may be immediate images output as results of performing the masking process on an actually measured camera image. The diagrams 610 and 640 may represent images when there is an undissolved material, and the diagrams 620 and 630 may represent images when the solute is completely dissolved.

In a graph 650, on the y-axis, a value may be assigned according to the dissolution state determined by the determination apparatus (e.g., Pass or Fail). In the graph 650, pass data (e.g., a data point corresponding an image in which a target sample is determined to be completely dissolved) may have x-axis values between 1.95 and 2.60, and fail data (e.g., a data point corresponding an image in which a target sample is determined to not be completely dissolved) may have x-axis values between 2.33 and 2.87. The values on the x-axis may represent entropy values of the images. The graph 650 shows the distribution of image entropy for each of the case of being dissolved (Pass) and the case of not being dissolved (Fail). In the graph 650, a value of a data point with respect to the y-axis may be expressed as 0 or 1 to indicate whether the target sample in a corresponding image is determined to be completely dissolved. The determination apparatus may use the image entropy shown through the graph 650 as one of the grounds for determining whether the target sample is dissolved.

FIG. 7 is a diagram illustrating a method of determining whether a target sample is dissolved according to an embodiment. In a graph 730 of FIG. 7, the x-axis represents the number of solute particles, and the y-axis represents the transparency (or opacity) of the solution.

The determination apparatus according to an embodiment may automatically determine whether the target sample is dissolved based on an image analysis result of the target sample. The determination apparatus may utilize the overall distribution of passes and fails according to the image entropy described above as a feature for determining whether the target sample is dissolved.

The determination apparatus may apply a median filter to the image of the target sample. The determination apparatus may remove dust on the camera(s) and/or dust on the container from the image of the target sample by applying the median filter to the image. The median filter may be a non-linear digital filter that may be used to remove noise from images or signals. The median filter may remove the noise using a median of surrounding pixel values. The determination apparatus may set a predetermined region (window) around a pixel to be filtered. The determination apparatus may set the window to a size of, for example, 3×3 or 5×5. The determination apparatus may align the pixel values within the window and then select the median thereof. The selected median may be a new pixel value for the corresponding pixel. The determination apparatus may remove salt-and-pepper noise from the image of the target sample by applying the median filter. The salt-and-pepper noise may correspond to noise in the form of white and black dots which are generated randomly in the image. The salt-and-pepper noise may be mainly generated when a pixel value of an image suddenly changes to 0 (black) or 255 (white).

Due to the influence of the edge detection and the primary masking by the detected outline of the container as described above with reference to FIG. 6, the edge may appear large in the corresponding portion. In an embodiment, secondary masking of the ROI may be performed with a mask having a radius slightly smaller than a radius of the ROI in order to remove the influence of edges appearing large in the image. The determination apparatus may count the number of particles remaining in the image as a result of the secondary masking, and use the number of particles as the feature for determining whether the target sample is dissolved. The determination apparatus may determine whether the target sample is dissolved based on a comparison result between the number of particles and a threshold value.

For example, when the number of particles remaining in the image, such as in the diagram 710 and the graph 730, exceeds a set threshold value (e.g., 5), the determination apparatus may determine that the dissolution state as the undissolved state, that is, the supersaturated state in which the solute particles are present in the solution, and output “Fail.”

For example, the threshold value may be a value greater than the number of solute particles included in the solution in a completely dissolved state where the solute particles are almost not present in the solution due to high solubility of the solution in which the target sample is dissolved, and may be a value less than or equal to the number of solute particles included in the solution in a crystallized state (or supersaturated state) where the solute extracted from the image is well dissolved in the solvent but is no longer dissolved at a predetermined concentration or higher and is present as solute particles, but is not limited thereto.

The determination apparatus may determine whether the type of the analysis result (Fail) is “Fail #1” corresponding to a turbid state or “Fail #2” corresponding to a “supersaturated state.” The determination apparatus may determine whether the target sample is dissolved by taking into account, in addition to the number of solute particles, the transparency (or opacity) of the solution displayed in the ROI and/or the presence of residue around the container.

For example, when the number of solute particles greatly exceeds the threshold value and the opacity of the solution displayed in the ROI is high, the determination apparatus may determine that the type of analysis result (Fail) is “Fail #1” corresponding to the “turbid state.” In contrast, when the number of solute particles is slightly greater than or equal to or the threshold value and the transparency of the solution displayed in the ROI is high, the determination apparatus may determine that the type of the analysis result (Fail) is “Fail #2” corresponding to the “supersaturated state.” For example, the determination apparatus may compare the number of solute particles with an additional threshold value that is greater than the threshold value to determine whether the type of analysis result (Fail) is “Fail #1” or “Fail #2.” For example, when the number of solute particles is equal to or greater than the additional threshold value, the determination apparatus may determine that the type of analysis result (Fail) is “Fail #1,” and when the number of solute particles is less than the additional threshold value, the determination apparatus may determine that the type of analysis result (Fail) is “Fail #2.”

When the type of analysis result (Fail) is determined as the turbid (“Fail #1”), the determination apparatus may generate a control signal for adjusting the temperature, adjusting the agitation speed, or increasing the reaction time to increase the dissolution degree of the target sample, and transmit the control signal to the driving module, such that the determination apparatus controls adjustment of the temperature, the agitation speed, or the reaction time. Thereafter, the determination apparatus may obtain an image after adjusting the temperature, adjusting the agitation speed, or increasing the reaction time according to the control signal.

When the type of analysis result (Fail) is determined as the supersaturated state (“Fail #2”), the determination apparatus may generate a control signal for adding a solvent, and transmit the control signal to the driving module, such that the determination apparatus causes the solvent to be added. The determination apparatus may obtain an image after the solvent is added according to the control signal.

For example, when the number of particles remaining in the image, such as in the diagram 710 and the graph 730, is less than or equal to a set threshold value (e.g., 5), the determination apparatus may determine the dissolution state as the completely dissolved state, and output “Pass.”

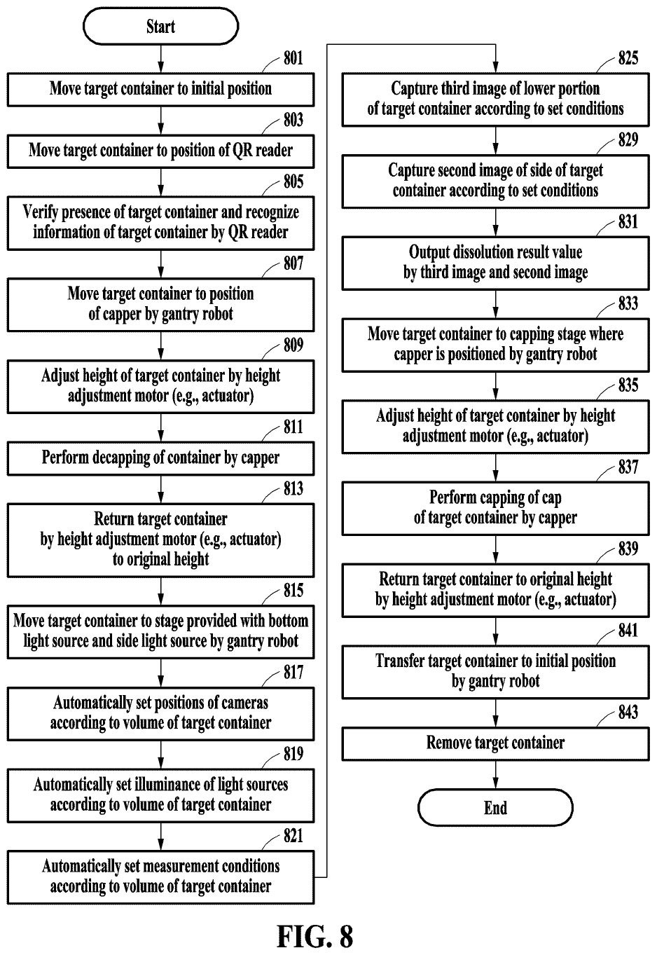

FIG. 8 is a flowchart illustrating a method of operating a dissolution determination apparatus according to an embodiment. Referring to FIG. 8, the determination apparatus according to an embodiment may perform an operation for determining whether the target sample is dissolved through operations 801 to 843.

In the operation 801, the determination apparatus may move the target container to an initial position. At this time, the determination apparatus may move the target container to the initial position by Universal Robots 5 (UR5). The UR5 may be a robotic arm (e.g., a robot hand or a gripper) for transferring the target container. The UR5 may be used to transfer the target container containing a reagent from a dispensing apparatus or an agitation apparatus to a solubility measurement apparatus. After the solubility measurement is complete, the UR5 may transfer the target container to another device for subsequent processing.

In the operation 803, the determination apparatus may move the target container to the position of the QR reader.

In the operation 805, the determination apparatus may recognize the information on the target container while simultaneously verifying the presence of the target container by the QR reader.

In the operation 807, the determination apparatus may move the target container to the position of the capper by the gantry robot. At this time, the gantry robot may move the target container to another position so as not to obstruct the image capturing, after moving the target container to the position of the capper.

In the operation 809, the determination apparatus may adjust the height of the target container by a height adjustment motor (e.g., an actuator). The determination apparatus may adjust the height of the target container so that the position of the cap of the target container reaches the position of the capper.

In the operation 811, the determination apparatus may perform the decapping of the target container by the capper. For example, the determination apparatus may control the capper to remove the cap from the target container.

In the operation 813, the determination apparatus may return the target container from its adjusted height in the operation 809 to its original height by the height adjustment motor (e.g., the actuator).

In the operation 815, the determination apparatus may move, by the gantry robot, the target container to a stage equipped with a bottom light source and a side light source.

In the operation 817, the determination apparatus may automatically set the positions of the camera(s) (e.g., the first camera, the second camera, and/or the third camera) according to the volume of the target container. At this time, the positions of the cameras may correspond to positions where the upper portion of the target sample contained in the target container, the side of the target sample, and the lower portion of the target sample may be imaged without obstruction.

In the operation 819, the determination apparatus may automatically set the illuminance of the light sources (e.g., the side light source and the bottom light source) according to the volume of the target container.

In the operation 821, the determination apparatus may automatically set measurement conditions according to the volume of the target container. The measurement conditions may be measurement conditions for image capturing, such as white balance, sharpness, exposure time, and the like. White balance may be used primarily in taking a photograph or video to adjust the color temperature to express natural colors. Sharpness may refer to the clarity and detail of an image in a photograph or video, and higher sharpness may imply that the image is clearer and has better details.

In the operation 825, the determination apparatus may capture a third image of a lower portion of the target container according to the set conditions of the operation 817 to the operation 821. The determination apparatus may capture the third image while the third camera faces toward the lower portion (e.g., bottom portion) of the target container, such that the third image is of the lower portion of the target sample. For example, the third camera may capture the third image while facing upwards towards the bottom portion of the target container.

In the operation 829, the determination apparatus may capture a second image towards a side of the target container according to the set conditions of the operation 817 to the operation 821. The determination apparatus may capture the second image while the second camera faces toward the side of the target container, such that the second image is of the side of the target sample. For example, the second camera may capture the second image while facing laterally towards the side of the target container.

In the operation 831, the determination apparatus may determine whether the target sample is dissolved and output an indication of the determination, (e.g., a dissolution result value (e.g., pass or fail)) based on the third image captured in the operation 825 and the second image captured in the operation 829.

In the operation 833, the determination apparatus may move, by the gantry robot, the target container to a capping stage where the capper is positioned.

In the operation 835, the determination apparatus may adjust the height of the target container by the height adjustment motor (e.g., the actuator). The determination apparatus may raise the height of the target container so that the position of the cap of the target container reaches the position of the capper to perform the capping of the cap of the target container.

In the operation 837, the determination apparatus may perform the capping of the target container by the capper. For example, the determination apparatus may control the capper to attach the cap to the target container.

In the operation 839, the determination apparatus may return, by controlling the height adjustment motor (e.g., the actuator), the target container from its adjusted height in the operation 835 to its original height (e.g., its height immediately before the operation 835).

In the operation 841, the determination apparatus may transfer the target container to the initial position by the gantry robot.

In the operation 843, the determination apparatus may remove the target container from the initial position by UR5.

The embodiments described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

While non-limiting example embodiments have been described with reference to the accompanying drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. Therefore, other implementations, other embodiments, and equivalents, including the above-described modifications and variations, are included within the spirit and scope of the present disclosure.

What is claimed is:

1. A dissolution determination apparatus comprising:
a reader configured to read identification information of a container that accommodates a target sample;
a driving module comprising at least one body, the at least one body of the driving module configured to open the container and move the container to a capturing position;
an image obtaining module configured to obtain, at the capturing position, at least one image of the target sample while the container is open; and
at least one processor configured to automatically determine whether the target sample is dissolved by analyzing the at least one image of the target sample based on the identification information of the container.

2. The dissolution determination apparatus of claim 1, wherein the reader is further configured to sense a position of the container.

3. The dissolution determination apparatus of claim 1, wherein the at least one body of the driving module comprises at least one from among:
a gripper configured to grip the container;
a robot configured to transfer the container to the capturing position along a transfer path;
an actuator configured to adjust at least one from among a height and a horizontal position of the container; and
a capper configured to open the container.

4. The dissolution determination apparatus of claim 1, wherein the image obtaining module comprises at least one from among:
a first camera configured to capture a first image of an upper portion of the target sample while the target sample is in the container and the container is open;
a second camera configured to capture a second image of a side of the target sample while the target sample is in the container and the container is open; and
a third camera configured to capture a third image of a lower portion of the target sample while the target sample is in the container, and
wherein the at least one processor is configured to automatically determine whether the target sample is dissolved by analyzing at least one from among the first image, the second image, and the third image of the target sample based on the identification information of the container.

5. The dissolution determination apparatus of claim 1, wherein the at least one processor is further configured to:
extract a region of interest (ROI) from the at least one image of the target sample;
calculate a noise level corresponding to the ROI through frequency-based filtering with respect to the ROI;
detect particles of an undissolved solute included in the ROI; and
determine whether the target sample is dissolved based on the noise level and the particles of the undissolved solute.

6. The dissolution determination apparatus of claim 5, wherein the at least one processor is further configured to detect the particles of the undissolved solute using at least one from among a bandpass filter, an adaptive thresholding, and a non-linear filter.

7. The dissolution determination apparatus of claim 5, wherein the at least one processor is further configured to:
extract features from the ROI;
obtain an analysis result by analyzing a dissolution degree of the target sample by applying the features to a neural network trained based on an analysis algorithm; and
generate a control signal based on the analysis result.

8. The dissolution determination apparatus of claim 7, wherein the analysis algorithm is configured to analyze at least one from among whether the target sample is completely dissolved, opacity of the target sample, the particles of the undissolved solute in the target sample, and a residue around the container.

9. The dissolution determination apparatus of claim 1, wherein the at least one processor is further configured to:
determine dissolution conditions corresponding to the target sample according to the identification information of the container; and
generate, based on determining that the target sample is not completely dissolved, a control signal for accelerating the dissolution of the target sample according to the dissolution conditions.

10. The dissolution determination apparatus of claim 9, wherein the dissolution conditions comprise at least one from among a type of a solvent for the dissolution of the target sample; an amount of the solvent; a type of a catalyst for the dissolution of the target sample; an amount, a temperature, a humidity, or a pressure of the catalyst; and a number of agitations of the container.

11. A method performed by a dissolution determination apparatus, the method comprising:
reading identification information of a container that accommodates a target sample;
opening the container;
moving the container to a capturing position;
obtaining, at the capturing position, at least one image of the target sample while the container includes the target sample and the container is open; and
automatically determining whether the target sample is dissolved by analyzing the at least one image of the target sample based on the identification information of the container.

12. The method of claim 11, wherein the opening the container comprises:
adjusting at least one from among a height and a position of the container; and
opening the container after the at least one from among the height and the position of the container is adjusted.

13. The method of claim 11, wherein the obtaining the at least one image of the target sample comprises:
capturing a first image of an upper portion of the target sample while the container includes the target sample and is open;
capturing a second image of a side of the target sample while the container includes the target sample and is open; and
capturing a third image of a lower portion of the target sample while the container includes the target sample.

14. The method of claim 11, wherein the automatically determining whether the target sample is dissolved comprises:
extracting a region of interest (ROI) from the at least one image of the target sample; and
determining whether the target sample is dissolved based on frequency-based filtering with respect to the ROI.

15. The method of claim 14, wherein the determining whether the target sample is dissolved based on the frequency-based filtering comprises:
calculating a noise level corresponding to the ROI using image entropy;
detecting particles of an undissolved solute included in the ROI through the frequency-based filtering with respect to the ROI; and
determining whether the target sample is dissolved based on the noise level and the particles of the undissolved solute.

16. The method of claim 15, wherein the detecting the particles of the undissolved solute comprises:
detecting the particles of the undissolved solute using at least one from among a bandpass filter, an adaptive thresholding, and a non-linear filter.

17. The method of claim 14, wherein the automatically determining whether the target sample is dissolved further comprises:
extracting features from the ROI;
obtaining an analysis result by analyzing a dissolution degree of the target sample by applying the features to a neural network trained based on an analysis algorithm; and
generating a control signal based on the analysis result.

18. The method of claim 17, wherein the analysis algorithm analyzes at least one from among whether the target sample is completely dissolved, opacity of the target sample, particles of an undissolved solute in the target sample, and a residue around the container.

19. The method of claim 11, wherein the automatically determining whether the target sample is dissolved comprises:
determining dissolution conditions corresponding to the target sample according to the identification information of the container; and
generating, based on determining that the target sample is not completely dissolved, a control signal for accelerating the dissolution of the target sample according to the dissolution conditions.

20. The method of claim 19, wherein the dissolution conditions comprise at least one from among a type of a solvent for the dissolution of the target sample; an amount of the solvent; a type of a catalyst for the dissolution of the target sample; an amount, a temperature, a humidity, or a pressure of the catalyst; and a number of agitations of the container.
